(19) United States
(12) Patent Application Publication
(10) Pub. No.: US 2019/0095181 A1
(43) Pub. Date: Mar. 28, 2019

(54) Easy-To-Use Type Of Compile-Time Dependency Injection Method And Device In The Java Platform

(71) Applicant: TMAXSOFT CO., LTD, Seongnam-si (KR)

(72) Inventor: Seonghwan JANG, Seongnam-si (KR)

(21) Appl. No.: 16/133,429

(22) Filed: Sep. 17, 2018

(30) Foreign Application Priority Data
Sep. 15, 2017 (KR) 10-2017-0118708

(51) Int. Cl. G06F 8/41; G06F 9/455

(52) U.S. Cl. CPC G06F 8/433; G06F 9/4552

(57) ABSTRACT

Disclosed is an easy-to-use type of a compile-time dependency injection method and device in a JAVA platform. According to an exemplary embodiment, there is provided a method for automatically generating a code which injects an object for a target code at the time of compiling, in a JAVA framework executing environment including: determining whether the target code is a code related with a dependency injection function; generating a provider code of the target code which generates an object and returns the generated object to the target code, based on the determination result; and generating an injector code including a dependency object injection code which injects a dependency object corresponding to at least one dependency injection indicator included in the target code into a dependency field of an object generated by the provider code, based on the determination result, in which the provider code calls the dependency object injection code.

### CROSS-REFERENCE TO RELATED APPLICATIONS

This application claims priority to and the benefit of Korean Patent Application No. 10-2017-0118708 filed in the Korean Intellectual Property Office on Sep. 15, 2017, the entire contents of which are incorporated herein by reference.

### TECHNICAL FIELD

The present disclosure relates to a framework for an application and more particularly to a dependency injection technology which facilitate development and maintenance of an application.

### BACKGROUND ART

A dependency injection framework which is widely used is mainly classified into two types. That is, the dependency injection framework is classified into a frame work (for example, a spring framework or a Google Guice) which performs injection through reflection at a runtime and a frame work (for example, Google dagger 2) which generates a source required for injection at a compiling timing and performs injection using the generated code.

Since the reflection adversely affects a runtime performance, an injection framework called dagger2 which does not affect the runtime performance has been developed and is frequently being used in the Android. However, there are disadvantages in that the dagger2 is difficult to use and inconvenient for users and uses a memory of a device a lot. This is because the user needs to essentially create component and module classes in the dagger and directly call an inject method of an object to be used as needed. This causes an increase in a class file necessary in an operating environment, which results in performance degradation based on a class loading time and an increase in a memory usage amount.

Therefore, a framework for overcoming the above-mentioned problems is being studied.

### SUMMARY OF THE INVENTION

The present disclosure has been made in an effort to provide an improved compile-time dependency injection framework.

Further, the present disclosure has been made in an effort to minimize the number of class files necessary at the time of compile-time dependency injection.

Furthermore, the present disclosure has been made in an effort to a method of injecting an object not only into a member field, but also into a local field.

An exemplary embodiment of the present disclosure provides a method for automatically generating a code which injects an object for a target code at the time of compiling, in a JAVA framework executing environment including: determining whether the target code is a code related with a dependency injection function; generating a provider code of the target code which generates an object and returns the generated object to the target code, based on the determination result; and generating an injector code including a dependency object injection code which injects at least one dependency object corresponding to at least one dependency injection indicator included in the target code into at least one dependency field of an object generated by the provider code, based on the determination result in which the provider code calls the dependency object injection code.

The dependency object injection code may call a provider code of at least one dependency object and the provider code of the dependency object generate a dependency object and returns the generated dependency object, the provider code of at least one dependency object may call an object injection code included in the injector code of at least one dependency object, when there is no sub dependency object in the dependency object, the object injection code may inject a new object into a dependency field of the object generated by the provider code of the dependency object, and when there is a sub dependency object in the dependency object, the object injection code may inject a sub dependency object of the dependency object into a dependency field of the object generated by the provider code of the dependency object.

When there is a sub dependency object in the dependency object so that a sub dependency object of the dependency object is injected into a dependency field, an object injection code included in the injector code of the dependency object may call a provider code of a sub dependency object, a provider code of the sub dependency object may call an injector code of the sub dependency object, and the injector code of the sub dependency object may include an object injection code.

Further, at least some types of codes included in the injector code are allowable in a local variable of a target code so that it allows at least a part of the object injected into a member field of the target code to be the same as at least a part of an object injected into the local variable of the target code.

The method may further include: determining whether there is scope information in the target code and the dependency object injection code may call a provider code of the dependency injection object based on the scope information.

The method may further include: determining whether there is a lazy injection indicator in the target code and when there is a lazy injection indicator, a dependency object injection code included in the injector code of the target code may provide a provider code of the dependency object to an object generated by the provider code of the target code.

According to another aspect of the present disclosure, a computer program stored in a computer readable storage medium including encoded commands, wherein when the computer program is executed by one or more processors of a computer system, the computer program allows the one or more processors to perform the following operations, and the operations may include: an operation of determining whether the target code is a code related with a dependency injection function; an operation of generating a provider code of the target code which generates an object and returns the generated object to the target code, based on the determination result; and an operation of generating an injector code including a dependency object injection code which injects at least one dependency object into at least one dependency field of an object generated by the provider code, based on the determination result and the provider code may call the dependency object injection code.

The dependency object injection code may call a provider code of at least one dependency object and the provide code of the dependency object generates a dependency object and returns the generated dependency object, the provider code of at least one dependency object may call an object injection code included in the injector code of at least one dependency object, when there is no sub dependency object in the dependency object, the object injection code may inject a new object into a dependency field of the object generated by the provider code, and when there is a sub dependency object in the dependency object, the object injection code may inject a sub dependency object of the dependency object into a dependency field of the object generated by the provider code.

According to an exemplary embodiment of the present disclosure, there may be provided an improved compile-time dependency injection framework.

Further, it is possible to improve application performance and reduce a memory usage amount in an operating environment, by minimizing the number of class files necessary at the time of compile-time dependency injection.

Further, a method which is capable of injecting objects not only into a member variable, but also into a local variable may be provided.

However, an effect of the present disclosure is not limited to the above description and other effects which have not been mentioned above will be apparent to those skilled in the art from a reading of the following description.

### BRIEF DESCRIPTION OF THE DRAWINGS

Various aspects are now described with reference to the drawings and like reference numerals are generally used to designate like elements. In the following exemplary embodiments, for a purpose of description, multiple specific detailed matters are presented to provide general understanding of one or more aspects. However, it will be apparent that the aspect(s) can be executed without the detailed matters. In other examples, known structures and apparatuses are illustrated in a block diagram form in order to facilitate description of the one or more aspects.

FIG. 1 is a block diagram for explaining a class generated by means of an annotation processor module according to an exemplary embodiment of the present disclosure.

FIG. 2 is a block diagram for explaining a method for automatically generating a code which injects an object for a target code according to an exemplary embodiment of the present disclosure at the time of compiling.

FIG. 3 is a view for explaining a method for returning an object into which all sub dependency objects are injected to a target code according to an exemplary embodiment of the present disclosure.

FIG. 4 is a view for explaining a method for generating an injector code when there is scope information in a target code according to an exemplary embodiment of the present disclosure.

FIG. 5 is a view for explaining a provider code and an injector code of a target code according to an exemplary embodiment of the present disclosure.

FIG. 6 is a view for explaining a method for injecting an object into a local variable according to an exemplary embodiment of the present disclosure.

FIGS. 7A, 7B, and 8 are views for explaining a lazy injection function and @Qualifier function according to another exemplary embodiment of the present disclosure.

FIG. 9 illustrates a simple and general schematic view of an exemplary computing environment in which exemplary embodiments of the present disclosure are embodied.

### DETAILED DESCRIPTION

The aforementioned objects, features, and advantages of the present disclosure will be clearer through the following exemplary embodiment associated with the accompanying drawings. The following specific structure or functional explanations are illustrated to describe exemplary embodiments in accordance with the concept of the present disclosure. The exemplary embodiments in accordance with the concept of the present disclosure may be embodied in various forms but are not interpreted to be limited to the exemplary embodiments described in this specification or application.

Various modifications and changes may be applied to the exemplary embodiments in accordance with the concept of the present disclosure and the exemplary embodiments may have various forms so that the exemplary embodiments will be described in detail in the specification or the application with reference to the drawings. However, it is not intended to limit the exemplary embodiments of the present disclosure within a specific disclosure, and it should be understood that the present disclosure covers all the modifications, equivalents and replacements within the spirit and technical scope of the present disclosure.

Terms of first and/or second may be used to describe various components but the components are not limited by the above terms. The above terms are used only to distinguish one component from the other components, for example, a first component may be referred to as a second component without departing from a scope in accordance with the concept of the present disclosure and similarly, a second component may be referred to as a first component.

It should be understood that, when it is described that a component is “coupled” or “connected” to another element, the element may be “directly coupled” or “directly connected” to the other element or “coupled” or “connected” to the other component through a third element. On the contrary, it should be understood that when an element is referred to as being “directly connected to” or “directly coupled to” another element, another element does not intervene therebetween. Other expressions to describe the relationship between elements, that is, the expressions such as “between”, “immediately between”, “adjacent to”, or “directly adjacent to” need to be also similarly interpreted.

Terms used in the present specification are used only to describe specific exemplary embodiments, and are not intended to limit the present disclosure. A singular form may include a plural form if there is no clearly opposite meaning in the context. In this specification, it should be understood that the term “include” or “have” indicates that a feature, a number, a step, an operation, a component, a part or the combination thereof described in the specification is present, but does not exclude a possibility of presence or addition of one or more other features, numbers, steps, operations, components, parts or combinations thereof, in advance.

If it is not contrarily defined, all terms used herein including technological or scientific terms have the same meaning as those generally understood by a person with ordinary skill in the art. Terms which are defined in a generally used dictionary should be interpreted to have the same meaning as the meaning in the context of the related art but are not interpreted as an ideally or excessively formal meaning if it is not clearly defined in this specification.

Hereinafter, exemplary embodiments of the present disclosure will be described in more detail with reference to the accompanying drawings.

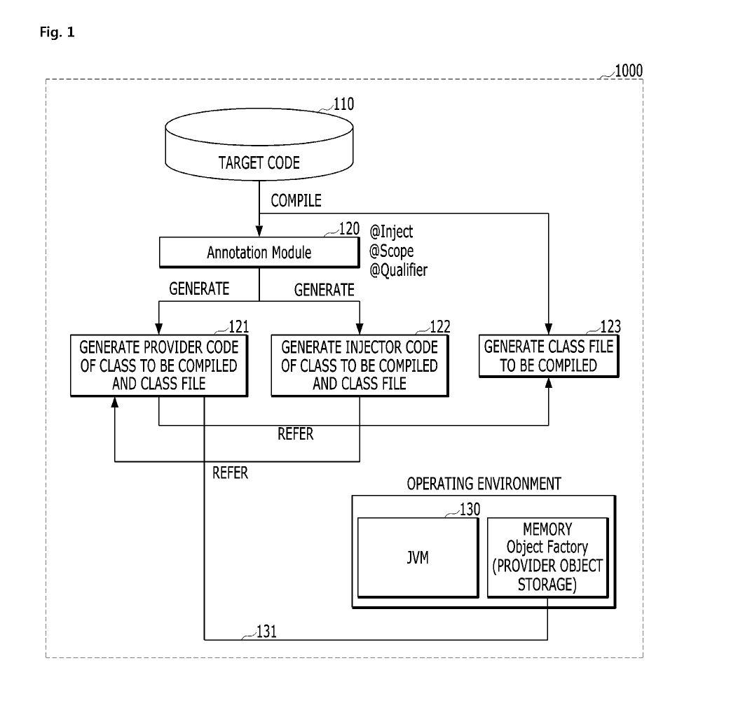

FIG. 1 is a block diagram for explaining a class generated by means of an annotation processor module according to an exemplary embodiment of the present disclosure.

Referring to FIG. 1, a device 1000 according to an exemplary embodiment of the present disclosure may include a compiler module and the compiler module may include an annotation processor module 120.

Further, the device 1000 according to an exemplary embodiment of the present disclosure may include a JAVA virtual machine module 130 and a memory 1106. The JAVA virtual machine module 130 may execute a class and the memory 1106 may store objects.

According to an exemplary embodiment of the present disclosure, the annotation processor module 120 may determine whether a target code is a code related with a dependency injection function at the time of compiling.

Further, the device 1000 may generate a provider code 121 and an injector code 122 of the target code based on the determination result.

The provider code may generate a target object and return the generated target object to the target code. For example, the provider code generates a target object corresponding to a dependency injection indicator, generates an object by injecting the object into a dependency field of the target object through the injector code and returns the generated object.

Further, when an object for a current target code is necessary as a dependency injection indicator in a different class, the provider code may provide the target object to a different class.

The injector code may inject the dependency object into a dependency field of the target object. For example, the provider code may call an injector code to inject an object into a field of the generated object and the injector code may inject the dependency code into the target field. For example, the injector code of the target code may call the provider code of the dependency object and the provider code of the dependency object may call an injector code of the dependency object, and the injector code of the dependency object may generate a new object and inject the generated object.

The dependency object may refer to an object of a different class, referred to by a dependency injection indicator (for example, @inject). For example, the device 1000 may retrieve an object defined in another object using the dependency injection indicator (for example, @inject).

When there is a sub dependency object in the dependency object, the injector code of the dependency object may call a provider code of the sub dependency object, the provider code of the sub dependency object may call an injector code of the sub dependency object, and the injector code of the sub dependency object may generate a new object and inject the generated object.

In this case, the sub dependency object may refer to a dependency object of the dependency object. For example, when the dependency object utilizes an object of a different class, there may be a sub dependency object in the dependency object.

The dependent relationship between modules is separated by a mutual relationship of the provider code of the target code generated by the device 1000 and the injector code of the target code so that maintenance time and cost of the application code may be saved.

Further, according to an exemplary embodiment of the present disclosure, the device 1000 does not need to generate a component class and a module class so that the number of necessary classes may be reduced.

The JAVA virtual machine module 130 may utilize the memory 1106 by dividing the memory 1106 into at least one of a perm space, a heap space, and a meta space. The JAVA virtual machine module 130 reads out the class file to store the class file in the perm space or the meta space area to be utilized at a run time. In this case, when the class file is reduced, a memory amount utilized in the memory is correspondingly reduced so that the memory usage rate may be improved by the above-described disclosure.

Further, a location where an instance (object) is stored is a heap space area. When the number of classes is reduced, the number of instances may be reduced. By doing this, the memory usage rate may be improved.

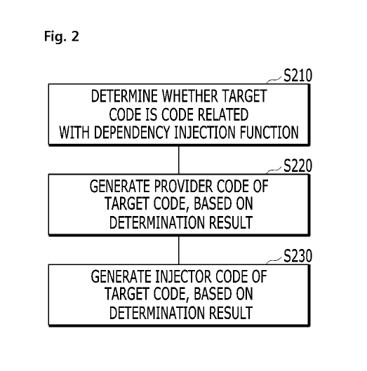

FIG. 2 is a block diagram for explaining a method for automatically generating a code which injects an object for a target code according to an exemplary embodiment of the present disclosure at the time of compiling.

In step S210, the device 1000 determines whether the target code is a code related with a dependency injection function.

In this case, the device 1000 may determine whether the target code is a code related with the dependency injection function based on class declaration information of the target code. For example, when the class declaration information of the target code indicates that a predetermined class is inherited (for example, when the class declaration information of the target code includes implement BusinessObject), the device 1000 may determine that the target code is a code related with the dependency injection function.

A method for determining whether the above-described target code is a code related with the dependency injection function is merely one exemplary embodiment. However, the method is not limited thereto and the device 1000 may determine whether the target code is a code related with the dependency injection function by various methods.

In step S220, the device 1000 may generate a provider code of the target code based on the determination result. For example, when it is determined that the target code is a code related with the dependency injection function, the device 1000 may generate a provider code. The provider code may generate an object and call an injector code of the target code to inject an object corresponding to at least one dependency injection indicator included in the target code into a dependency field of the generated object and return the generated object to the target code.

For example, whether there are X dependency injection indicators in the target code, the provider code generates a target object and injects objects corresponding to the X dependency injection indicators into the dependency field of the generated target object through the injector code of the target code and returns the target object to the target code.

In this case, the dependency injection indicator may be implemented in form of @inject. A type of above-described dependency injection indicator is merely an exemplary embodiment and is not limited thereto and may be implemented in various forms.

In step S230, the device 1000 may generate an injector code of the target code based on the determination result. For example, when it is determined that the target code is a code related with the dependency injection function, the device 1000 may generate an injector code of the target code. The injector code of the target code may include a dependency object injection code which injects a dependency object into a dependency field of the target object generated by the provider code of the target code.

In this case, the dependency object may be distinguished by a dependent injection identifier which is located to be close to the dependency injection indicator. For example, the dependency injection indicator (for example, @inject) may be located to be adjacent to the dependency injection identifier (for example, Client client;) and the device 1000 may determine a dependency object based on the dependency injection identifier.

The dependency object injection code may call a provider code of the dependency object and the called provider code of the dependency object may call an injector code of the dependency object. For example, the dependency object injection code (for example, inject method) included in the injector code of the target code may call a get method code included in the provider code of the dependency object. The get method code of the dependency object may call an object injection code (for example, inject method) included in the injector code of the dependency object.

In this case, the get method code refers to a code which generates an object and returns the generated object. For example, the get method code generates an object, injects the object through an object injection code included in the injector code of the dependency object into the dependency field of the generated code and returns the generated object. The object injection code may refer to a code which injects another code (for example, a dependency object) into a dependency field generated by a get method code.

When there is no sub dependency object in the dependency object, the object injection code may inject a new object into the dependency field. For example, the object injection code generates a new object and injects the generated new object into the dependency field.

When there is a sub dependency object in the dependency object, the sub dependency object of the dependency object may be injected into the dependency object. For example, the object injection code of the dependency object may call a provider code of a sub dependency object and the provider code of the sub dependency object may call an injector code of the sub dependency object. Specifically, for example, the object injection code of the dependency object may call a get method code included in the provider code of the sub dependency object and the called get method code may call an object injection code included in the injector code of the sub dependency object.

When there is no sub dependency object (hereinafter, referred to as a secondary sub dependency object) in the sub dependency object, an object injection code of the sub dependency object may generate a new object and inject the generated object into a dependency field of an object generated by a provider code of the sub dependency object. When there is a secondary sub dependency object in the sub dependency object, an object injection code of the sub dependency object may call a provider code of the secondary sub dependency object and the provider code of the secondary sub dependency object may call an injector code of the secondary sub dependency object.

The target code may be provided with a dependency object into which all objects having sub dependency are injected by repeating the above-described processes.

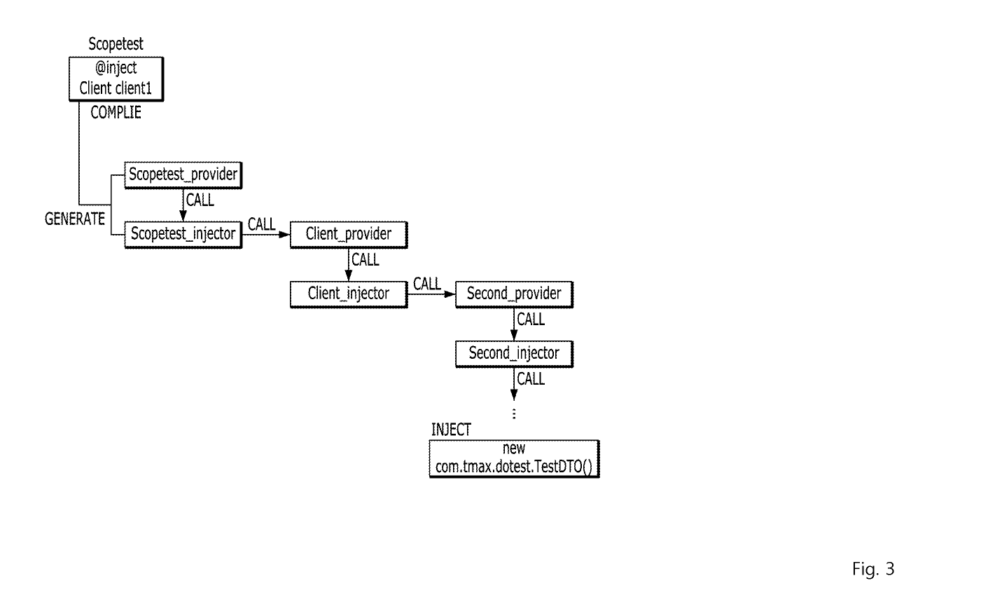

FIG. 3 is a view for explaining a method for returning an object into which all sub dependency objects are injected to a target code according to an exemplary embodiment of the present disclosure.

According to an exemplary embodiment of the present disclosure, the device 1000 may determine whether the target code is related with the dependency injection function at the time of compiling. For example, it is determined whether the target code Scopetest inherits a predetermined class. When the target code Scopetest inherits the predetermined class, the device 1000 may determine that the target code is related with the dependency injection function.

When the target code is related with the dependency injection function, the device 1000 may generate a provider code Scopetest_provider of the target code and an injector code Scopetest_injector of the target code.

In this case, the generated provider code of the target code may include a code which calls the injector code of the target code. Specifically, the provider code of the target code may include a get method code and the get method code may call a dependency object injection code included in the injector code of the target code.

The dependency object injection code included in the injector code of the target code may call a provider code Client_provider of the dependency object and the provider code Client_provider of the dependency object may call an injector code Client_injector of the dependency object. Specifically, the provider code Client_provider of the dependency object may include a get method code and the get method code may call an object injection code included in the injector code Client_injector of the dependency object.

When there is no sub dependency object in the dependency object, the object injection code included in the injector code Client_injector of the dependency object may generate a new object and provide the generated object to the provider code of the dependency object.

When there is a sub dependency object in the dependency object, the injector code Client_injector of the dependency object may call a provider code Second_provider of a sub dependency object and the provider code Second_provider of the sub dependency object may call an injector code Second_provider of the sub dependency object. Specifically, the provider code Second_provider of the sub dependency object may include a get method code and the get method code may call an object injection code included in the injector code Second_injector of the sub dependency object.

When there is no sub dependency object (hereinafter, referred to as a secondary sub dependency object) in the sub dependency object, the object injection code included in the injector code Second_injector of the sub dependency object may generate a new object and provide the generated object to the provider code of the sub dependency object. Further, when there is a sub dependency object (hereinafter, referred to as a secondary sub dependency object) in the sub dependency object, the object injection code included in the injector code Second_injector of the sub dependency object may call a provider code of the secondary sub dependency object.

According to the exemplary embodiment of the present disclosure, the provider code of the sub dependency object and the injector code of the sub dependency object may be called until there is no sub dependency object of the object. When there is no sub dependency object, an injector code of the last sub dependency object may generate a new object and inject the generated object into a dependency field generated by the provider code. As a result, the target code may be provided with an object into which all objects having sub dependency are injected.

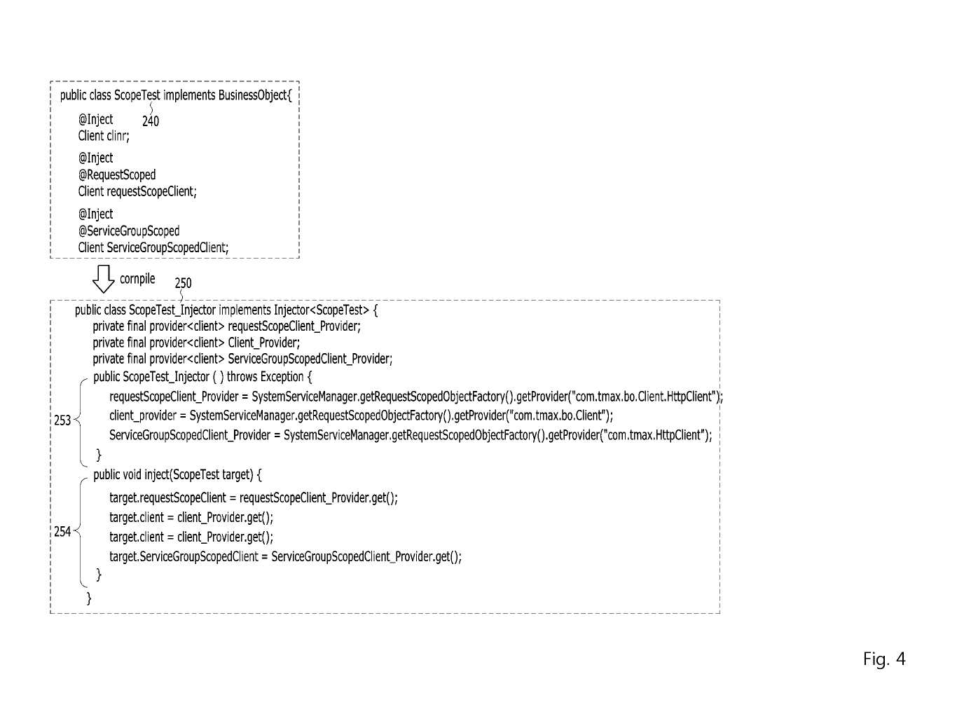

FIG. 4 is a view for explaining a method for generating an injector code when there is scope information in a target code according to an exemplary embodiment of the present disclosure.

According to an exemplary embodiment of the present disclosure, the device 1000 may determine whether there is scope information in the target code. The scope information refers to information which allows a provider code of the dependency object called by an injector code of the target information to be distinguished.

For example, the device 1000 may be provided with a provider code of a dependency object from an object factory code stored in a memory. In this case, there may be a plurality of object factory codes in the memory and the scope information may indicate at least one of the plurality of object factory codes.

Specifically, for example, first scope information may indicate a first object factory code. In this case, the first object factory code may refer to a code which provides the same object to the same class type until the end of the service request.

As another example, second scope information may indicate a second object factory code and the second object factory code may refer to a code which provides the same object during a period when a class loader of a particular object is maintained.

Referring to FIG. 4, there may be scope information in the target code. For example, there may be @RequestScoped and @ServiceGroupScoped as the target code, but the target code is not limited thereto.

The device 1000 may determine whether there is scope information in the target code at the time of compiling. Further, an injector code of the target code may be generated based on the existing scope information.

For example, when there is scope information in the target code (@RequestScoped), a code 253 which designates a provider code of the dependency object included in the injector code of the target code may designate the provider code corresponding to the scope information as a provider code of the dependency object and the dependency object injection code may include a code 254 which calls a designated provider code of the dependency object.

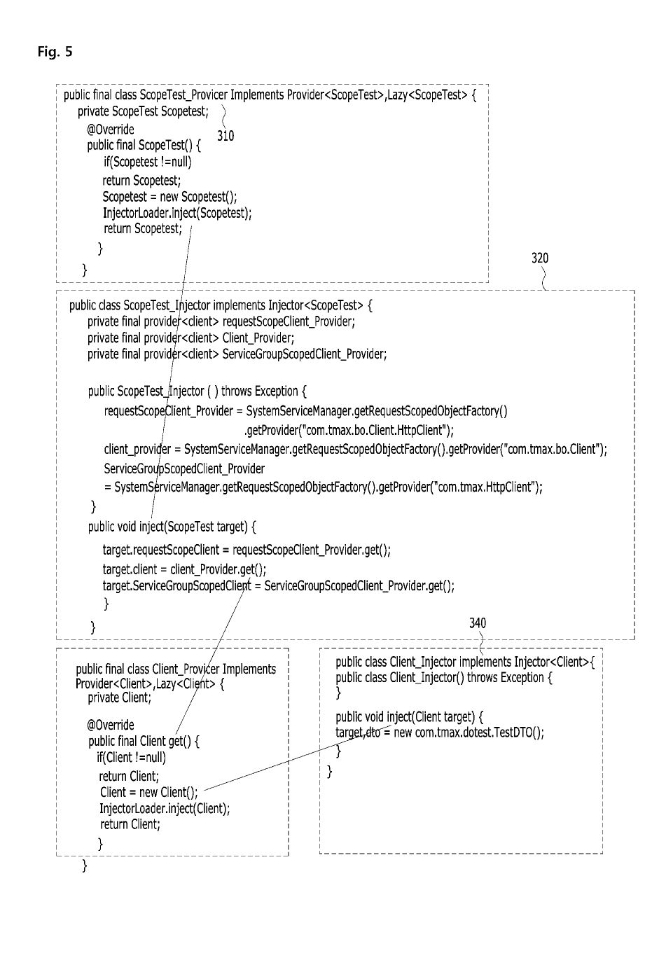

FIG. 5 is a view for explaining a provider code and an injector code of a target code according to an exemplary embodiment of the present disclosure.

According to an exemplary embodiment of the present disclosure, the device 1000 may determine whether the target code Scopetest is a code related with the dependency injection function at the time of compiling. For example, the device 1000 may determine whether the target code is a code related with the dependency injection function based on class declaration information of the target code. Specifically, for example, when the target code inherits a predetermined class (for example, implement businessObject is included in the target code), the device 1000 may determine that the target code is related with the dependency injection function.

When the target code is related with the dependency injection function, the device 1000 may generate a provider code Scopetest_provider 310 of the target code and an injector code Scopetest_injector 320 of the target code.

In this case, the generated provider code 310 of the target code may include a code which calls the injector code of the target code. Specifically, the provider code of the target code may include a get method code and the get method code may call a dependency object injection code included in the injector code 320 of the target code in order to generate a target object and inject a dependency object into a dependency field of the target object.

The dependency object injection code included in the injector code 320 of the target code may call a provider code Client_provider 330 of the dependency object and the provider code Client_provider 330 of the dependency object may call an injector code Client_injector 340 of the dependency object. Specifically, the provider code Client_provider 330 of the dependency object may include a get method code and the get method code may call an object injection code included in the injector code Client_injector 340 of the dependency object in order to generate an object and inject another object into a dependency field of the object.

When there is no sub dependency object in the dependency object, the object injection code included in the injector code Client_injector 340 of the dependency object may generate a new object and provide the generated object to the provider code of the dependency object.

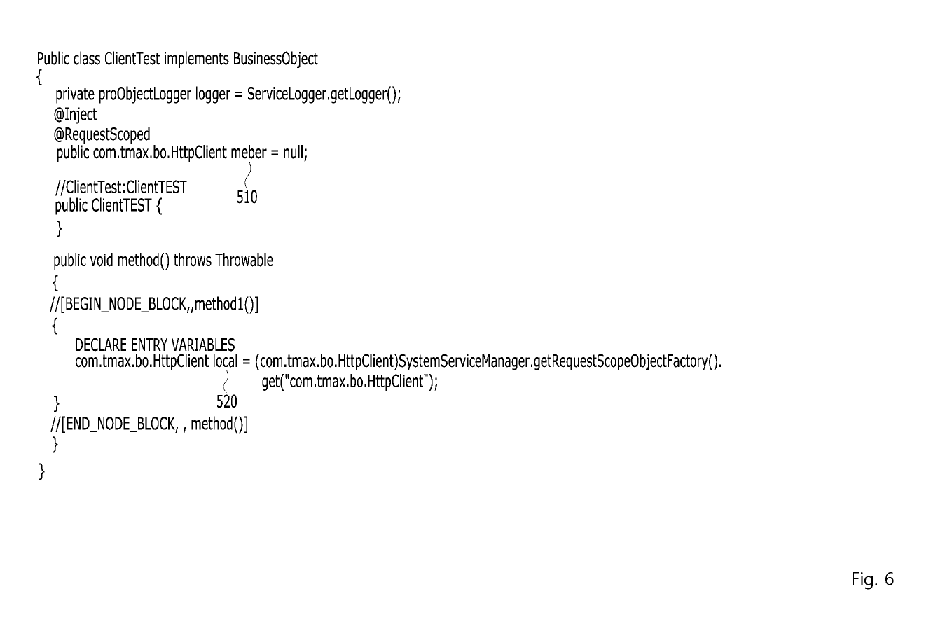

FIG. 6 is a view for explaining a method for injecting an object into a local variable according to an exemplary embodiment of the present disclosure.

Referring to FIG. 6, the device 1000 injects the object which is provided from the same provider code provided from the same object factor code into a member field 510 and a local field 520 so that the same object may be injected into the member field 510 and the local field 520.

For example, a type of code which designates a provider code of the dependency object included in the injector code of the target code may be implemented to be utilized in the local field 520.

As a result, the provider code of the dependency object which is called by the injector code of the target code may be the same as the provider code of the dependency object called by the local field 520, so that the same object as the object which is injected into the member field of the target code may be injected into the local field of the target code.

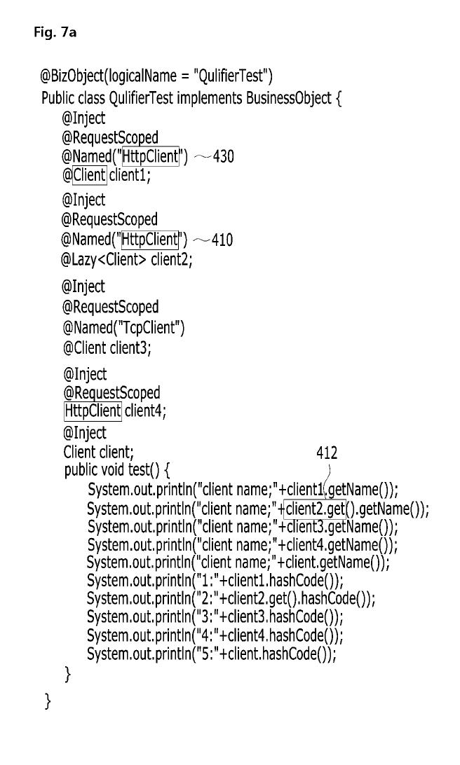

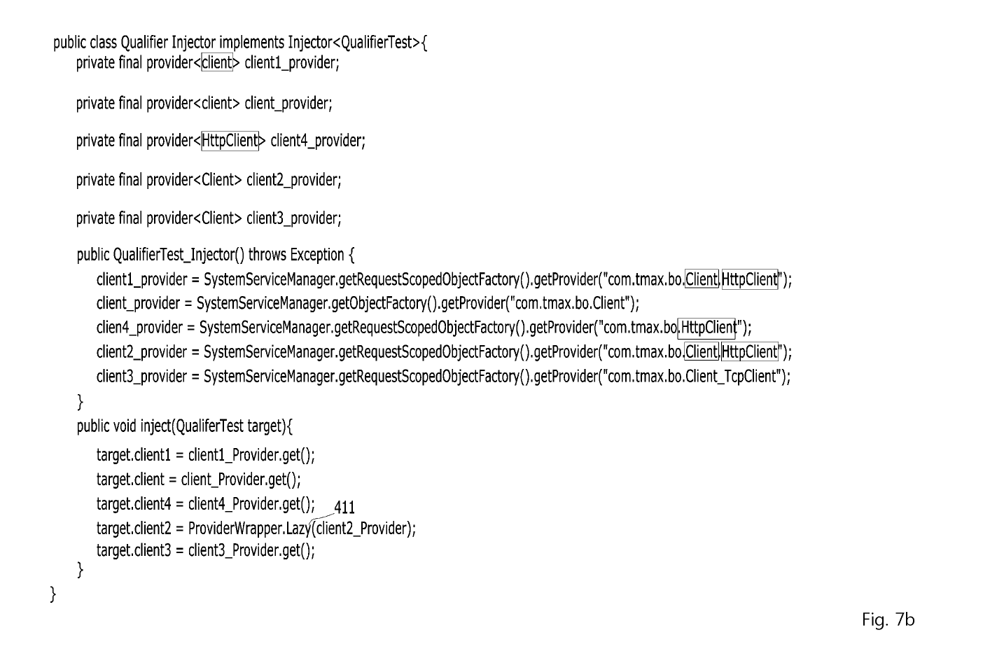

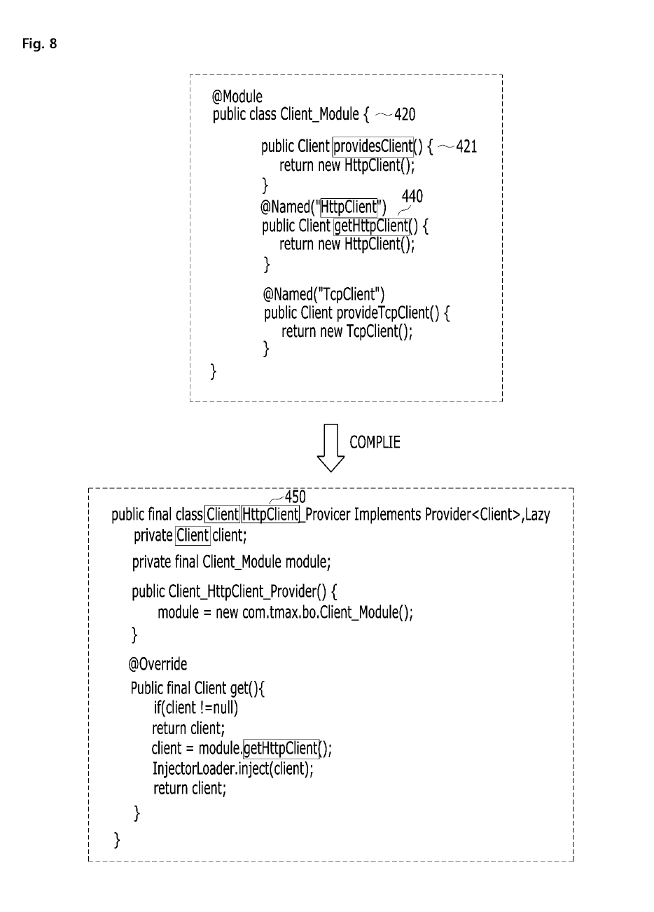

FIGS. 7A, 7B, and 8 are views for explaining a lazy injection function and @Qualifier function according to another exemplary embodiment of the present disclosure.

The device 1000 according to the exemplary embodiment of the present disclosure may generate an injector code of a target code which provides a lazy injection function.

The device 1000 may determine whether there is a lazy injection indicator in the target code. For example, the device 1000 may determine whether there is a “Lazy<Type>” code in the target code. The above-described code is merely an exemplary embodiment of the lazy injection indicator and a type of lazy injection indicator is not limited thereto.

When there is a lazy injection indicator in the target code, the injector code of the target code generated by the device 1000 may provide a provider code to the object generated by the provider code of the target code, rather than an actual object. For example, the dependency object injection code of the injector code does not inject the dependency object, but provides a provider code of the dependency object.

As a result, when the lazy object is used (412), the user may be provided with an object from the provider code so that it is easy to manage the objects.

According to the exemplary embodiment of the present disclosure, in order to provide a sub class which inherits a declared type to @inject target, information on implementation which will be returned is additionally necessary. To this end, @module class 420 is generated. When a method 421 named “Provides class name” is generated in @module class, the provider calls the method 421 to provide a returned object.

According to an exemplary embodiment of the present disclosure, when @module is used, objects which will be actually injected to every place where @inject target class is applied may be changed to be applied only to @module. Further, when @Named is utilized, different implementations may be designated for every @inject target. When @Named is used, the same value may be declared in a place 420 where @inject is used and a method 440 of @Module. In this case, a provider 450 which calls a method 440 designated in @module is additionally generated and an object may be provided from the provider 450 generated at the place where @injector is used.

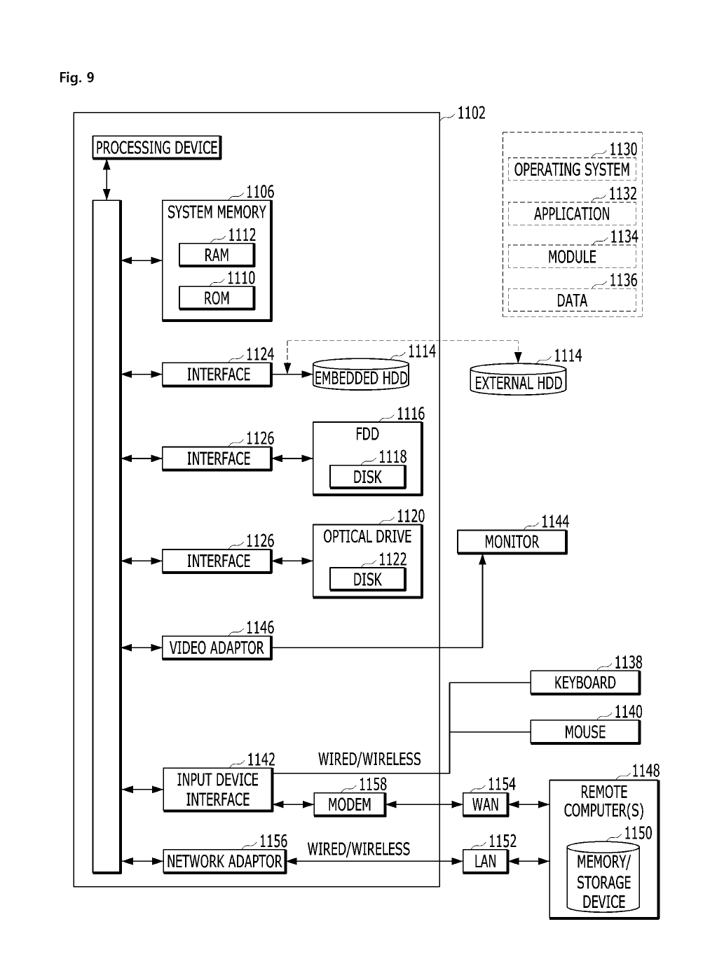

FIG. 9 illustrates a simple and general schematic view of an exemplary computing environment in which exemplary embodiments of the present invention are embodied.

Even though it is described that the present disclosure is generally implemented by the device 1000, it is obvious to those skilled in the art that the present disclosure may be implemented by being coupled with a computer executable instruction which may be executed on one or more computers and/or other program modules and/or may be implemented by a combination of hardware and software. In this case, the device 1000 may include a database server and a computer, but is not limited thereto.

Generally, the program module includes a routine, a program, a component, a data structure, or the like which performs a specific task or implements a specific abstract data type. Further, those skilled in the art may well understand that the method of the present disclosure may be embodied not only by a single processor or a multi-processor computer system, a mini computer, and a main frame computer, but also a personal computer, a hand-held computing apparatus, microprocessor based or programmable home appliances (which may be connected to one or more related devices to be operated), and other computer system configurations.

The described exemplary embodiments of the present disclosure may also be embodied in a distributed computing environment in which some tasks are performed by remote processing devices which are connected to each other through a communication network. In the distributed computing environment, a program module may be located in both local and remote memory storing devices.

Generally, a computer includes various computer readable media. If a medium is accessible by the computer, the any medium may be a computer readable medium and the computer readable medium includes a volatile or non-volatile medium, a transitory or non-transitory medium, and a mobile or non-mobile medium. As an example which is not a limitation, the computer readable medium may include a computer readable storage medium and a computer readable transmission medium. The computer readable storage medium includes a volatile or non-volatile medium, a transitory or non-transitory medium, and a mobile or a non-mobile medium which are implemented by an arbitrary method or technique which stores information such as a computer readable instruction, a data structure, a program module or other data. The computer storage medium includes a RAM, a ROM, an EEPROM, a flash memory, or other memory techniques, a CD-ROM, a digital video disk (DVD), or other optical disk storing devices, a magnetic cassette, a magnetic tape, a magnetic disk storing device, or other magnetic storing devices, or other arbitrary media which are accessed by a computer and are used to store desired information, but is not limited thereto.

The computer readable transmission medium generally implements a computer readable instruction, a data structure, a program module, or other data in a modulated data signal such as a carrier wave or other transport mechanism and includes all information transfer medium. The term ‘modulated data signal’ refers to a signal in which one or more of the properties of the signal are set or changed to encode information in the signal. As an example which is not a limitation, the computer readable transmission medium includes a wired medium such as a wired network or direct wired connection and a wireless medium such as sound, RF, infrared ray, or other wireless medium. It is considered that a combination of any of the above-mentioned media may also be included in the scope of the computer readable transmission medium.

An exemplary environment 1100 including a computer 1102 which implements various aspects of the present disclosure is illustrated and the computer 1102 includes a processing device 1104, a system memory 1106, and a system bus 1108. The system bus 1108 connects system components including a system memory 1106 (not to be limited thereto) to the processing device 1104. The processing device 1104 may be an arbitrary processor among various commercial processors. A dual processor and other multiprocessor architectures may also be used as the processing device 1104.

The system bus 1108 may be any of several types of bus structures which is additionally connected to a local bus which uses any one of a memory bus, a peripheral device bus, and various commercial bus architectures. The system memory 1106 includes a read only memory (ROM) 1110 and a random access memory (RAM) 1112. A basic input/output system (BIOS) is stored in a non-volatile memory 1110 such as a ROM, an EPROM, and an EEPROM and the BIOS includes a basic routine which assists to transmit information between components in the computer 1102 while the computer is activated. The RAM 1112 may further include a fast RAM such as a static RAM for caching data.

The computer 1102 further includes an embedded hard disk drive (HDD) 1114 (for example, EIDE, SATA) which may also be configured as an external drive in an appropriate chassis (not illustrated), a magnetic floppy disk drive (FDD) 1116 (for example, to read data from a portable diskette 1118 or record data therein), and an optical disk driver 1120 (for example, to read a CD-ROM disk 1122 or read data from other high quantity optical medium such as a DVD or record data therein). The hard disk drive 1114, the magnetic disk drive 1116, the optical disk drive 1120 may be connected to the system bus 1108 through a hard disk drive interface 1124, a magnetic disk drive interface 1126, and an optical drive interface 1128. The interface 1124 for implementing an external drive includes at least one or both of universal serial bus (USB) and IEEE 1394 interface technique.

These drives and a computer readable medium related therewith provide non-volatile storage of data, a data structure, a computer executable instruction, or the like. In the case of the computer 1102, the drive and the medium correspond to storing arbitrary data as an appropriate digital type. In the description of the computer readable medium, an HDD, a portable magnetic disk, and a portable optical medium such as a CD or a DVD have been mentioned. However, it is well known to those skilled in the art that other types of computer readable media such as a zip drive, a magnetic cassette, a flash memory card, or a cartridge may also be used in an exemplary operating environment and the arbitrary medium may include a computer executable instruction which performs the methods of the present disclosure.

A large number of program modules including an operating system 1130, one or more application programs 1132, other program module 1134, and program data 1136 may be stored in the drive and the RAM 1112. The operating system, the application, the module and/or all or a part of data may also be cached by the RAM 1112. It is obvious that the present disclosure may be implemented by various commercially applicable operating systems or a combination of operating systems.

A user may input a command and information to the computer 1102 through one or more wired/wireless input devices, for example, a pointing device such as a keyboard 1138 and a mouse 1140. Other input devices (not illustrated) may include a microphone, an IR remote controller, a joystick, a game pad, a stylus pen, a touch screen, or the like. These and other input devices are sometimes connected to the processing device 1104 through an input device interface 1142 which is connected to the system bus 1108, but may be connected by a parallel port, an IEEE 1394 serial port, a game port, a USB port, an IR interface, or other interfaces.

A monitor 1144 or other types of display devices is also connected to the system bus 1108 through an interface such as a video adaptor 1146. In addition to the monitor 1144, a computer generally includes other peripheral output devices (not illustrated) such as a speaker or a printer.

The computer 1102 may operate in a networked environment using logical connection of remote computer(s) 1148 to one or more remote computers through wired and/or wireless communication. The remote computer(s) 1148 may be a workstation, a computing device computer, a router, a personal computer, a portable computer, a microprocessor based amusement machine, a peer device, or other general network node and generally, includes a large number of or all the components which have been described for the computer 1102. However, for the purpose of simplicity, only a memory storing device 1150 is illustrated. The illustrated logical connection includes wired/wireless connection to a local area network (LAN) 1152 and/or larger network, for example, a wide area network (WAN) 1154. The LAN and WAN networking environments are general in an office and a company and facilitate enterprise-wide computer network such as Intranet and these are all connected to a worldwide computer network, for example, Internet.

When the computer 1102 is used in the LAN networking environment, the computer 1102 is connected to a local network 1152 through a wired and/or wireless communication network interface or an adaptor 1156. The adaptor 1156 facilitates wired or wireless communication to the LAN 1152 and the LAN 1152 also includes a wireless access point provided therein to communicate with the wireless adaptor 1156. When the computer 1102 is used in the WAN networking environment, the computer 1102 has other means which, for example, includes a modem 1158 or is connected to a communication computing device on the WAN 1154, or uses Internet to set communication through the WAN 1154. The modem 1158 which may be an embedded or external, and wired or wireless device is connected to the system bus 1108 through the serial port interface 1142. In a networked environment, program modules described for the computer 1102 or a part thereof may be stored in the remote memory/storing device 1150. It is understood well that the illustrated network connection is an example and other means to set a communication link between computers may be used.

The computer 1102 performs operations to communicate with an arbitrary wireless device or entity which is disposed through wireless communication to operate, for example, a printer, a scanner, a desktop and/or portable computer, a portable data assistant (PDA), a communication satellite, arbitrary equipment or location related with a wireless detectable tag, and a telephone. This includes at least a Wi-FI and Bluetooth wireless technology. Therefore, communication may be a previously defined structure such as a network of the related art or simply ad hoc communication between at least two devices.

Wi-Fi (wireless fidelity) may allow connection to the Internet without using a wire. The Wi-Fi is a wireless technique such as a cell phone which allows such a device, for example, a computer to transmit and receive data indoor and outdoor, that is, in any place within a coverage of a base station. The Wi-Fi network uses a wireless technology called IEEE 802.11 (a,b,g, or the like) to provide safe, reliable, and fast wireless connection. Wi-Fi may be used to connect computers to each other or to the Internet, and a wired network (IEEE 802.3 or Ethernet is used). The Wi-Fi network operates, for example, at a 11 Mbps (802.11a) or 54 Mbps (802.11b) data rate in an unauthorized wireless band of 2.4 and 5 GHz or operates in a product including both bands (dual band).

According to an exemplary embodiment of the present disclosure, a compiler module, an annotation processor module 120, and a JAVA virtual machine module 130 may be included in the processing device 1000. Further, according to another exemplary embodiment of the present disclosure, a compiler module, an annotation processor module 120, and a JAVA virtual machine module 130 may be included in a module 1134.

Those skilled in the art may understand that information and signals may be represented using various arbitrary technologies and techniques. For example, data, indications, commands, information, signals, bits, symbols, and chips which may be referred in the above description may be represented by voltages, currents, electromagnetic waves, magnetic fields or particles, optical fields or particles, or an arbitrary combination thereof.

Those skilled in the art may understand that various exemplary logical blocks, modules, processors, units, circuits, and algorithm steps which have been described with respect to the exemplary embodiments disclosed herein may be implemented by electronic hardware, various types of programs (for the convenience, referred to as “software” here), a design code, or a combination thoseof. In order to clearly describe compatibility of hardware and software, various exemplary components, blocks, modules, circuits, and steps are generally described above with respect to functions thoseof. Whether these functions are implemented as hardware or software is determined depending on design restrictions which are applied to a specific application and the entire system. Those skilled in the art may implement the function, which is described by various methods, of the specific application but the implementation determination is not interpreted to depart from the scope of the present disclosure.

Various exemplary embodiments suggested herein may be implemented by a method, a device, or a standard programing and/or an article using an engineering technique. The term “article” includes a computer program which is accessible from an arbitrary computer readable storage device, a carrier or a medium. For example, the computer readable storage medium includes a magnetic storing device (for example, a hard disk, a floppy disk, or a magnetic strip), an optical disk (for example, a CD or a DVD), a smart card, and a flash memory device (for example, an EEPROM, a card, a stick, or a key drive), but is not limited thereto. Further, various storage media suggested herein include one or more devices for storing information and/or other machine readable media.

It should be understood that a specific order or a hierarchical structure of steps in suggested processes is examples of exemplary approaches. It should be understood that a specific order or a hierarchical structure of steps in the processes may be rearranged within the scope of the present disclosure, based on a design priority. The accompanying method claims provide elements of various steps in the order of sample, but the claims are not meant to be limited to the suggested specific order or hierarchical structure.

Description of the suggested exemplary embodiment is provided to allow those skilled in the art to use or embody the present disclosure. Various modifications of the exemplary embodiments may be apparent to those skilled in the art and general principles defined herein may be applied to other exemplary embodiments without departing from the scope of the present disclosure. Therefore, the present disclosure is not limited to the exemplary embodiments suggested herein, but interpreted in the broadest range which is consistent with principles suggested herein and new features.

What is claimed is:

1. A method for automatically generating a code which injects an object for a target code at the time of compiling, in a JAVA framework executing environment, the method comprising:
determining whether the target code is a code related with a dependency injection function;
generating a provider code of the target code which generates an object and returns the generated object to the target code, based on the determination result; and
generating an injector code including a dependency object injection code which injects at least one dependency object corresponding to at least one dependency injection indicator included in the target code into at least one dependency field of an object generated by the provider code, based on the determination result,
wherein the provider code calls the dependency object injection code.

2. The method of claim 1, wherein the dependency object injection code calls a provider code of at least one dependency object and the provider code of the dependency object generates a dependency object and returns the generated dependency object, the provider code of at least one dependency object calls an object injection code included in the injector code of at least one dependency object, when there is no sub dependency object in the dependency object, the object injection code injects a new object into a dependency field of the object generated by the provider code of the dependency object, and when there is a sub dependency object in the dependency object, the object injection code injects a sub dependency object of the dependency object into a dependency field of the object generated by the provider code of the dependency object.

3. The method of claim 2, wherein when there is a sub dependency object in the dependency object so that a sub dependency object of the dependency object is injected into a dependency field, an object injection code included in the injector code of the dependency object calls a provider code of a sub dependency object, a provider code of the sub dependency object calls an injector code of the sub dependency object, and the injector code of the sub dependency object includes an object injection code.

4. The method of claim 1, wherein at least some types of codes included in the injector code are allowable in a local variable of a target code so that it allows at least a part of the object injected into a member field of the target code to be the same as at least a part of an object injected into the local variable of the target code.

5. The method of claim 2, further comprising:
determining whether there is scope information in the target code,
wherein the dependency object injection code calls a provider code of the dependency injection object based on the scope information.

6. The method of claim 1, further comprising:
determining whether there is a lazy injection indicator in the target code,
wherein when there is a lazy injection indicator, a dependency object injection code included in the injector code of the target code provides a provider code of the dependency object to an object generated by the provider code of the target code.

7. A computer program stored in a computer readable storage medium including encoded commands, wherein when the computer program is executed by one or more processors of a computer system, the computer program allows the one or more processors to perform operations, and the operations comprise:
an operation of determining whether the target code is a code related with a dependency injection function;
an operation of generating a provider code of the target code which generates an object and returns the generated object to the target code, based on the determination result; and
an operation of generating an injector code including a dependency object injection code which injects at least one dependency object into at least one dependency field of an object generated by the provider code, based on the determination result, and the provider code calls the dependency object injection code.

8. The computer program stored in a computer readable storage medium according to claim 7, wherein the dependency object injection code calls a provider code of at least one dependency object and the provider code of the dependency object generates a dependency object and returns the generated dependency object, the provider code of at least one dependency object calls an object injection code included in the injector code of at least one dependency object, when there is no sub dependency object in the dependency object, the object injection code injects a new object into a dependency field of the object generated by the provider code, and when there is a sub dependency object in the dependency object, the object injection code injects a sub dependency object of the dependency object into a dependency field of the object generated by the provider code.
